(19) United States
(12) Patent Application Publication
(10) Pub. No.: US 2020/0313989 A1
(43) Pub. Date: Oct. 1, 2020

(54) METHOD AND APPARATUS FOR VARIABLE SAMPLING FOR OUTLIER MINING

(71) Applicant: International Business Machines Corporation, Armonk, NY (US)

(72) Inventors: Ofer Haim Biller, Midreshet Ben Gurion (IL); Hagit Grushka, Beer Sheva (IL); Bracha Shapira Bracha Shapira, Beer Sheva (IL); Oded Sofer, Midreshet Ben Gurion (IL)

(21) Appl. No.: 16/367,434

(22) Filed: Mar. 28, 2019

(51) Int. Cl. H04L 12/26; G06N 20/00; H04L 12/24

(52) U.S. Cl. CPC H04L 43/08; H04L 41/16; G06N 20/00

(57) ABSTRACT

A method, system and computer program product, the method comprising: sampling data from a computer network for training a monitoring system, comprising: obtaining information about the computer network to be monitored; obtaining indicators of available resources for collecting training data from the computer network; receiving mandatory objects to be monitored within the computer network; selecting at least one object to be monitored from under-monitored objects within the computer network, said selecting based upon monitoring resources remaining after reducing resources required for monitoring the mandatory objects, from the available resources; and sampling data in accordance with the selection.

### TECHNICAL FIELD

The present disclosure relates to network monitoring systems in general, and to a method and apparatus for sampling training data for training a monitoring system, in particular.

### BACKGROUND

Any computing or computerized entity, including computing platforms, peripherals, applications, files, databases, database tables, or others are vulnerable to various computerized attacks, including viruses, Trojan horses, or any other malware, as well as malicious user actions. Such malware or actions may cause severe harm, including but not limited to destroyed computer platforms or other hardware devices, data loss, malicious data manipulation, data corruption, unwanted transmissions or sharing, or the like.

Many protection schemes have been designed to fight and protect against such attacks. Some schemes attempt to learn the “normal” behavior of a network, a system, a platform, a database, or any other entity, such that abnormal behavior can be identified and prevented, stopped, reported, or the like.

However, the resources available for monitoring a system are seldom sufficient for collecting all data from all objects. This is particularly true for the learning phase, for which it is generally agreed that sampling more data provides for better coverage and better learning of the normal behavior of the system. However, due to the limited resources, prioritization needs to take place, such that the sampled data provides the best protection against attacks.

### BRIEF SUMMARY

One exemplary embodiment of the disclosed subject matter is a computer-implemented method comprising: sampling data from a computer network for training a monitoring system, comprising: obtaining information about the computer network to be monitored; obtaining indicators of available resources for collecting training data from the computer network; receiving mandatory objects to be monitored within the computer network; selecting an object to be monitored from under-monitored objects within the computer network, said selecting based upon monitoring resources remaining after reducing resources required for monitoring the mandatory objects, from the available resources; and sampling data in accordance with the selection. Within the method, the available resources indicators optionally comprise indicators of resource availability predicted for a future time. The method can further comprise training a classification engine upon the sampled data, to obtain a trained classifier. The method can further comprise sampling further data comprising a multiplicity of data items from the computer network; classifying the multiplicity of data items by the trained classifier, for determining whether any of the multiplicity of data items poses a hazardous situation; and in response to any of the multiplicity of data items posing a hazardous situation, taking an action. Within the method, the action is optionally selected from the group consisting of: stopping an operation; blocking communication; blocking a user account; shutting down a computing platform; and issuing a notification to an operator. Within the method, sampling the data optionally continues until one or more conditions are met, at least one of the conditions selected from the group consisting of: a minimum amount of data as defined by a user has been sampled; and at least four weeks of sampling have passed. Within the method selecting the object can further comprise: determining an under-monitored object; clustering monitored objects in the computer network into a plurality of clusters; determining a cluster from the plurality of clusters for the under-monitored object; and subject to a distance between the under-monitored object and the cluster being below a predetermined value, and to having at least a predetermined amount of data for an object within the cluster, skipping sampling the under-monitored object. Within the method, sampling data from the computer network is optionally performed in an ongoing manner.

Another exemplary embodiment of the disclosed subject matter is a system having a processor, the processor being adapted to perform the steps of: sampling data from a computer network for training a monitoring system, comprising: obtaining information about the computer network to be monitored; obtaining indicators of available resources for collecting training data from the computer network; receiving mandatory objects to be monitored within the computer network; selecting an object to be monitored from under-monitored objects within the computer network, said selecting based upon monitoring resources remaining after reducing resources required for monitoring the mandatory objects, from the available resources; and sampling data in accordance with the selection. Within the system, the available resources indicators optionally comprise indicators of resource availability predicted for a future time. Within the system, the processor is optionally further adapted to train a classification engine upon the sampled data, to obtain a trained classifier. Within the system, the processor is optionally further adapted to: collect further data comprising a multiplicity of data items from the computer network; classify the multiplicity of data items by the trained classifier, for determining whether any of the multiplicity of data items poses a hazardous situation; and in response to any of the multiplicity of data items posing a hazardous situation, take an action. Within the system, the action is optionally selected from the group consisting of: stopping an operation; blocking communication; blocking a user account; shutting down a computing platform; and issuing a notification to an operator. Within the system, sampling the data optionally continues until one or more conditions are met, at least one of the conditions selected from the group consisting of: a minimum amount of data as defined by a user has been sampled; and at least four weeks of sampling have passed. Within the system, the processor selecting the object is optionally further configured to: determine an under-monitored object; cluster monitored objects in the computer network into a plurality of clusters; determine a cluster from the plurality of clusters for the under-monitored object; and subject to a distance between the under-monitored object and the cluster being below a predetermined value, and to having at least a predetermined amount of data for an object within the cluster, skip sampling the under-monitored object. Within the system, sampling data from the computer network is optionally performed in an ongoing manner.

Yet another exemplary embodiment of the disclosed subject matter is a computer program product comprising a non-transitory computer readable medium retaining program instructions, which instructions when read by a processor, cause the processor to perform: sampling data from a computer network for training a monitoring system, comprising: obtaining information about the computer network to be monitored; obtaining indicators of available resources for collecting training data from the computer network; receiving mandatory objects to be monitored within the computer network; selecting an object to be monitored from under-monitored objects within the computer network, said selecting based upon monitoring resources remaining after reducing resources required for monitoring the mandatory objects, from the available resources; and sampling data in accordance with the selection.

### THE BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1 shows a flowchart diagram of a method for collecting and using monitoring data in a computer network, in accordance with some exemplary embodiments of the disclosed subject matter; and

Referring now to FIG. 2 showing a block diagram of a computing device configured for collecting and using monitoring data in a computer network, in accordance with some exemplary embodiments of the disclosed subject matter.

### DETAILED DESCRIPTION

The term “object” used in this specification should be expansively construed to cover any kind of computing or computerized entity, including but not limited to a computing platform, a server, a laptop, a mobile phone, a tablet, a file, a folder, a library, an executable, an application, a service, a database, a database part such as a table, an index or others, a user account, or the like. In some embodiments, a user performing actions involving one or more such objects may also be considered an object.

The term “learning” used in this specification should be expansively construed to cover any kind of a computer paradigm in which data related to the behavior of one or more objects is collected (also referred to as sampled), and processed, also related to as a “training” phase, the output of which is a model. The training phase is followed by a “testing” phase in which run time data is collected and tested against the model, which outputs whether the data represents normal behavior or not, in which case it may be suspected to be hazardous. Some learning paradigms are supervised, such that a user labels any piece of data as “normal” or “abnormal” or other classes, and the trained model provides an indication for tested pieces of data whether they are more similar to the abnormal or to the normal corpus, and are thus hazardous or not. Other paradigms are unsupervised, in which it is assumed that all training data is normal, and anything that does not comply with, or has low probability to be associated with the model trained upon the training data is abnormal.

Further paradigms are semi-supervised, and provide a hybrid approach in which training is performed without supervision, but the trained models may be strengthened by labeled data. The data may be labeled by a user, a system, or the like.

One technical problem is the need to collect training data for a network computer. Although a large quantity of training data is preferable, the collection and processing resources are generally limited, thus necessitating sampling of the data, in order to comply with the resource limitation.

Another technical problem is that some data, for example data related to certain objects, users, or the like, must be collected in order to comply with laws, regulations, internal procedures, or the like.

Yet another technical problem is that the sampled data represents as much as possible all activities within the computer network, and not limit the collection to certain objects, users, or the like.

One technical solution comprises selective sampling of data items, comprising data or activities related to objects within the computer network, such as instructions or messages sent to or from objects, activities in the network such as manipulating databases, database objects, files, user activities or the like. Sampling is planned and performed in accordance with the available resources, e.g., bandwidth, processing power, storage space, time, or the like.

Collection may continue for a predetermined period of time, for example one day, one week, one month, or the like. The available resources may thus change over the collection time. For example, during weekends more processing power and more bandwidth may be available, as people are not operating the computers. Therefore, the available resources may be computed not only based on the momentary availability but also on the predicted availability. Thus, in some embodiments, the predetermined period of time may be at least one month, in order to cover the one week cycle and the one month cycle, during which weekly and monthly operations such as backup, are performed. Selecting such time frame provides for these operations to be sampled as part of the normal activity within the network.

Additionally or alternatively, collection may continue until a user-defined volume of data is gathered for each object or for a multiplicity of objects. In further embodiments, collection may continue until sufficient amount of data has been collected, wherein sufficient data may relate to a number of data items which is at least a predetermined multiplication of the number of objects involved. Collecting may continue until one or more of the conditions above are fulfilled.

It will be appreciated that the type of data items to be sampled may be predetermined in accordance with user directions, or set according to user guidelines, such as which activities are to be monitored for each object, activities related to a user-object combination, or the like.

Usage of the resources available for collecting the training set may be planned as follows:

First, the resources required for collecting mandatory data are determined. Mandatory data may depend on the applicable requirements. In some non-limiting examples, where General Data Protection Regulation (GDPR) is applicable, privacy-related data may be collected; where Health Insurance Portability and Accountability Act (HIPPA) is applicable, health-related data is collected, and similarly for Payment Card Industry (PCI) in the financial field.

The available resources remaining after allocating resources to the mandatory data items may be allocated to the different objects as follows: it may be determined which objects are under-monitored, and resources may be allocated to these objects, rather than to the ones for which sufficient amount of data items has been collected.

In order to select the under-monitored objects, the monitored objects may be clustered into one or more classes. Clustering can be based on static parameters such as type of object, and/or dynamic parameters, such as data collected regarding the objects.

It may then be checked to which cluster the under monitored objects should be assigned, and what is the minimal distance between an object and the corresponding cluster. If an under-monitored object is within a small, e.g. below a threshold, distance from a cluster, the object may be ignored, as data collected regarding other objects represents that object, too. Thus, an object which is rather far from a cluster may be selected.

Then, objects for which sufficient amount of data has been collected may be taken out of the collection scheme, unless they are mandatory, and selected under-monitored objects may be added, such that collection continues to add new and representative data items related to objects that have not been sufficiently represented before. However, the object replacement may be made gradual, by replacing a limited number of objects every time, in order to maintain stability.

Additionally, objects may have priorities, such that under monitored objects having higher priority are entered into the sampling scheme before objects having lower priority.

A model may then be trained using any employed learning paradigm upon the collected data, and used for checking runtime data for hazardous situations.

Collection and retraining the model may continue on an ongoing basis, to ensure that the trained model represents the current activity within the system.

One technical effect of the disclosure relates to collecting data from a computerized network for training a model, wherein the model may be used for monitoring ongoing activity in the network for safety. Thus, a minimal amount of data needs to be collected in order to comply with the model limitations, and provide an efficient engine.

Another technical effect of the disclosure relates to collecting data in accordance with the resources available for collecting, wherein the resource availability relates not only to the onset of the collection, but also to the availability at future times.

Yet another technical effect of the disclosure relates to ensuring that mandatory data, e.g. data related to laws, internal or external regulations or procedures or others is collected continuously.

Yet another technical effect of the disclosure relates to spreading the collection over multiple objects and object type, to avoid repeatedly sampling activity of certain objects or object types. Rather, objects or object types for which insufficient amount of data has been collected take precedence over others. However, the changeover between the objects or object types that are being sampled is not abrupt but rather gradual which helps maintain model stability.

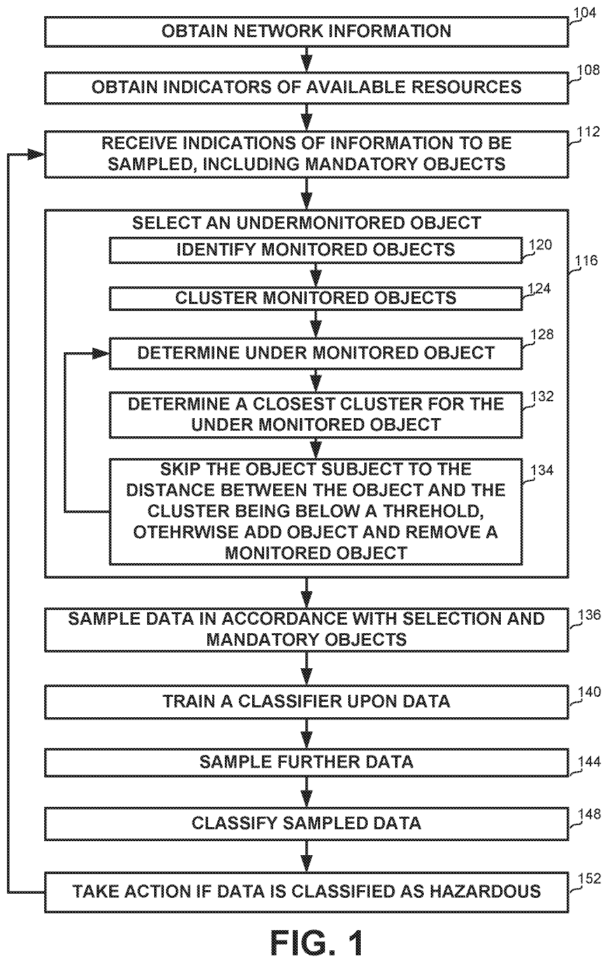

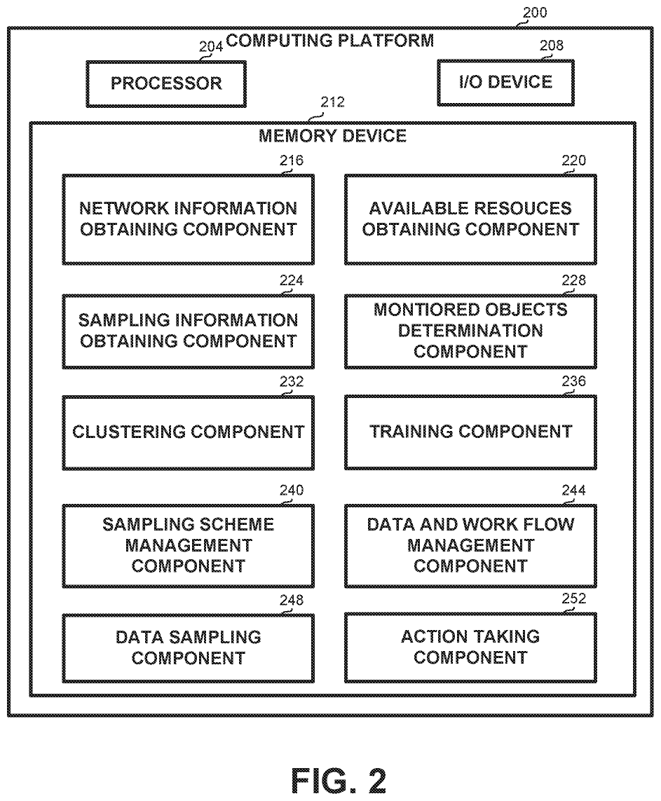

Referring now to FIG. 1, showing a flowchart diagram of a method for collecting and using monitoring data in a computer network.

On step 104, network information may be obtained. The information may be retrieved from a storage device, received from a user, or realized by mapping the network and communicating with the computing platforms and other objects on the network. In some embodiments, a combination of two or more of the above may be used, such that some objects are detected from investigating the network structure, while other objects may be received from a user or retrieved from a storage device.

On step 108, the resources available for collecting data, or indicators thereof are obtained. The resources may include the available computing capacity of computing platforms used for collecting the information, the available storage space, bandwidth, time limitations, or the like. The resource indicators may also refer to future time, for example the resources expected to be available on weekends, on following weeks, or the like.

On step 112, indications of the data items to be sampled may be received. The indications may include identification of objects to be fully monitored, combinations of objects or object types and activities to be monitored, guidelines, for example combination of every object type and every activity type, or the like. In addition, objects or activity types which are mandatory, under any law, regulation, client requirements, procedures, or the like, may be received. In some exemplary embodiments, sampling may include but is not limited to any one or more of the following monitoring options: monitoring connections only, e.g., login/logout/session start/session end, with the relevant attributes; monitoring the first N activities wherein N is an integer number; monitoring M seconds every N seconds; monitoring specific objects, or the like. On step 116 an under-monitored object may be selected, as detailed below.

On step 136 data collection may be performed, such that the mandatory objects or activities are monitored, as well as one or more under monitored objects or activities as determined on step 116. In some embodiments, the collection scheme may not be abruptly changed, by replacing all sufficiently monitored objects by under-monitored objects, but rather be changed gradually, for example by replacing one, two or any predetermined number of objects at a time. The gradual change may provide for higher stability of the generated model, to ensure consistent yet updated monitoring behavior.

On step 140, a classifier may be trained upon the collected data. In some embodiments, if supervised or semi-supervised learning is employed, user labeling of the collected data may be required prior to training. The trained classifier may be configured to receive a data item representing one or more objects and one or more activities, and issue a classification. The classification may be binary, e.g., hazardous/non-hazardous. Alternatively, the classifier may output a number indicating a probability that an input data item is hazardous.

On step 144, run-time monitoring may begin or proceed, wherein data is sampled for the objects, activities, mandatory objects or activities, as received. Alternatively, further data may also be collected regarding additional objects and activities.

On step 148, one or more sampled data item may be provided as input to the classifier.

On step 152, in case of a binary classifier, if one or more data items are classified as hazardous, an action may be taken, such as stopping an activity, blocking communication, halting a computing device or peripheral, sending a message to a person in charge such as an operator, or the like. In case of a non-binary classifier, whether a data item should be investigated further, or whether an action is to be taken may depend on a threshold which may be general, object-specific, activity-specific, user-specific or any other criteria. The threshold may also depend on the resources available for monitoring the system. If the probability output by the classifier for the data item to be hazardous exceeds the threshold, an action may be taken as detailed above.

Referring now back to step 116 of selecting an under-monitored object. The steps below provide an exemplary embodiment of the selection.

On step 120, the objects that have been sufficiently monitored may be identified. Sufficiently monitored may refer to completion of the time frame during which the object has been monitored, for example one week, one month, or the like. Alternatively, the data sufficiency may relate to the volume of data or the number of data items collected exceeding a predetermined of a dynamic threshold.

On step 124, the monitored objects may be clustered. The metrics upon which the clustering is performed may relate to the characteristics of the object, for example its type: computing platform, database, file, peripheral device, or the like; on the activities related to the object such as access, transmission, manipulation, or the like, optionally including the activity type, date, time, or the like; a user or process associated with the object or the activity; or any combination thereof.

On step 128, one or more under monitored objects may be identified, being the objects that have not been identified as monitored on step 120.

On step 132, the under monitored objects, being the objects that have not been identified as monitored on step 120 are tested. Testing may include determining a distance to the closest cluster, i.e., a distance between the object and the cluster that contains objects which are most similar to the object, under the clustering metrics,

If the distance to the closest cluster is below a threshold, the object may be considered similar to monitored objects.

Thus, on step 134, monitoring the object may be skipped if the distance is indeed smaller than the threshold, since it may not add significant information. Otherwise, the object may be added to the data collection scheme. Since the resource limitation still exists, a monitored object may be taken off the scheme to allow resources to the under monitored object.

Testing may then continue for further under monitored objects, until a stopping criterion may be reached. One stopping criteria may be that no under monitored object has been detected. Another exemplary criterion may be that a maximal number of under monitored objects that are not similar to other objects have been found. In this case, since the addition of a new object implies stopping the monitoring of a fully monitored object (unless it is a mandatory object), in order to maintain stability of the model, the number of replaced objects may be limited.

It will be appreciated that the under monitored objects may be ordered, for example using a risk score or a priority, such that higher risk objects or objects having higher priority, and data items related to such objects, may be sampled prior to collecting information related to lower priority objects.

Once the objects to be monitored are determined, execution can proceed on step 136 as detailed above.

It will be appreciated that collecting samples and updating the model may be an ongoing process, such that the network is monitored with an updated model that represents the current situation, thus enabling to detect current data outliers. However, steps such as clustering the monitored objects may be performed periodically, and not every time

Referring now to FIG. 2 showing a block diagram of a computing device configured for collecting and using monitoring data in a computer network.

The system comprises one or more computing platforms 200. In some embodiments, computing platform 200 may be a server, and provide services to one or more computer networks to be monitored. In some embodiments, computing platform 200 may be a part of a monitored computer network.

Computing platform 200 may communicate with other computing platforms via any communication channel, such as a Wide Area Network, a Local Area Network, intranet, Internet or the like.

Computing Platform 200 may comprise a Processor 204 which may be one or more Central Processing Unit (CPU), a microprocessor, an electronic circuit, an Integrated Circuit (IC) or the like. Processor 204 may be configured to provide the required functionality, for example by loading to memory and activating the modules stored on Storage Device 212 detailed below.

It will be appreciated that Computing Platform 200 may be implemented as one or more computing platforms which may be in communication with one another. It will also be appreciated that Processor 204 may be implemented as one or more processors, whether located on the same platform or not.

Computing Platform 200 may also comprise Input/Output (I/O) Device 208 such as a display, a pointing device, a keyboard, a touch screen, or the like. I/O Device 208 may be utilized to receive input from and provide output to a user, for example receive a mandatory objects, output monitoring results, or the like.

Computing Platform 200 may also comprise a Storage Device 212, such as a hard disk drive, a Flash disk, a Random Access Memory (RAM), a memory chip, or the like. In some exemplary embodiments, Storage Device 212 may retain program code operative to cause Processor 204 to perform acts associated with any of the modules listed below or steps of the method of FIG. 1 above. The program code may comprise one or more executable units, such as functions, libraries, standalone programs or the like, adapted to execute instructions as detailed below.

Storage Device 212 may comprise Network Information Obtaining Component 216, for receiving or determining objects within the computer network to be monitored.

Storage Device 212 may comprise Available Resources Obtaining Component 220, for receiving or determining the resources available for sampling and processing the sampled data. The available resources may be determined for the present time as well as for future times.

Storage Device 212 may comprise Sampling Infraction Obtaining Component 224 for receiving the objects, activities, users or other entities for which information is to be sampled. Sampling Infraction Obtaining Component 224 may also be configured to receive indications of mandatory objects, activities or users to be sampled.

Storage Device 212 may comprise Monitored Objects Determination Component 228 for determining the objects that for which sufficient data has been sampled.

Storage Device 212 may comprise Clustering Component 232 which may handle all clustering functionality, including clustering a multiplicity of data items, and receiving a data item and determining a cluster closest to the data item, and optionally the distance therebetween.

Storage Device 212 may comprise Training Component 232 for receiving a multiplicity of data items and training a classifier upon the data items. In some embodiments, if training is required for supervised or semi-supervised learning, training component 236 may also comprise a user interface component for a user to label the data.

Storage Device 212 may comprise Sampling Scheme Management Component 240 for handling the sampling scheme, including making sure that the mandatory objects are being sampled, and that under monitored objects are being are being entered into the sampling scheme instead of monitored objects, while complying with the available resource limitations.

Storage Device 212 may comprise Data and Workflow Management Component 244 for activating the components, and providing each component with the required data. For example, Data and Workflow Management Component 244 may be configured to obtain data items collected when the system is being monitored, provide it to the trained classifier, and receive an indication whether the data items is hazardous or not.

Storage Device 212 may comprise Data Sampling Component 248 for sampling objects and activities within the computer network, in accordance with the scheme, for training the model, and afterwards as part of monitoring the network, wherein during monitoring data may also be sampled for further training.

Storage Device 212 may comprise Action Taking Component 252, for taking actions if a sampled data item is classified as hazardous.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method, comprising:
sampling data from a computer network for training a monitoring system, comprising:
obtaining information about the computer network to be monitored;
obtaining indicators of available resources for collecting training data from the computer network;
receiving mandatory objects to be monitored within the computer network;
selecting at least one object to be monitored from under-monitored objects within the computer network, said selecting based upon monitoring resources remaining after reducing resources required for monitoring the mandatory objects, from the available resources; and
sampling data in accordance with the selection.

2. The method of claim 1, wherein the available resources indicators comprise indicators of resource availability predicted for a future time.

3. The method of claim 1, further comprising training a classification engine upon the sampled data, to obtain a trained classifier.

4. The method of claim 3, further comprising:
sampling further data comprising a multiplicity of data items from the computer network;
classifying the multiplicity of data items by the trained classifier, for determining whether any of the multiplicity of data items poses a hazardous situation; and
in response to any of the multiplicity of data items posing a hazardous situation, taking at least one an action.

5. The method of claim 4, wherein the at least one action is selected from the group consisting of: stopping an operation; blocking communication; blocking a user account; shutting down a computing platform; and issuing a notification to an operator.

6. The method of claim 1, wherein sampling the data continues until at least one condition is met, the at last one condition selected from the group consisting of: a minimum amount of data as defined by a user has been sampled; and at least four weeks of sampling have passed.

7. The method of claim 1, wherein selecting the at least one object further comprising:
determining at least one under-monitored object;
clustering monitored objects in the computer network into a plurality of clusters;
determining a cluster from the plurality of clusters for the at least one under-monitored object; and
subject to a distance between the under-monitored object and the cluster being below a predetermined value, and to having at least a predetermined amount of data for at least one object within the cluster, skipping sampling the under-monitored object.

8. The method of claim 1, wherein sampling data from the computer network is performed in an ongoing manner.

9. A system having a processor, the processor being adapted to perform the steps of:
sampling data from a computer network for training a monitoring system, comprising:
obtaining information about the computer network to be monitored;
obtaining indicators of available resources for collecting training data from the computer network;
receiving mandatory objects to be monitored within the computer network;
selecting at least one object to be monitored from under-monitored objects within the computer network, said selecting based upon monitoring resources remaining after reducing resources required for monitoring the mandatory objects, from the available resources; and
sampling data in accordance with the selection.

10. The system of claim 9, wherein the available resources indicators comprise indicators of resource availability predicted for a future time.

11. The system of claim 9, wherein the processor is further adapted to train a classification engine upon the sampled data, to obtain a trained classifier.

12. The system of claim 11, wherein the processor is further adapted to:
collect further data comprising a multiplicity of data items from the computer network;
classify the multiplicity of data items by the trained classifier, for determining whether any of the multiplicity of data items poses a hazardous situation; and
in response to any of the multiplicity of data items posing a hazardous situation, take at least one an action.

13. The system of claim 12, wherein the at least one action is selected from the group consisting of: stopping an operation; blocking communication; blocking a user account; shutting down a computing platform; and issuing a notification to an operator.

14. The system of claim 9, wherein sampling the data continues until at least one condition is met, the at last one condition selected from the group consisting of: a minimum amount of data as defined by a user has been sampled; and at least four weeks of sampling have passed.

15. The system of claim 11, wherein the processor selecting the at least one object is further configured to:
determine at least one under-monitored object;
cluster monitored objects in the computer network into a plurality of clusters;
determine a cluster from the plurality of clusters for the at least one under-monitored object; and
subject to a distance between the under-monitored object and the cluster being below a predetermined value, and to having at least a predetermined amount of data for at least one object within the cluster, skip sampling the under-monitored object.

16. The system of claim 11, wherein sampling data from the computer network is performed in an ongoing manner.

17. A computer program product comprising a non-transitory computer readable medium retaining program instructions, which instructions when read by a processor, cause the processor to perform:
sampling data from a computer network for training a monitoring system, comprising:
obtaining information about the computer network to be monitored;
obtaining indicators of available resources for collecting training data from the computer network;
receiving mandatory objects to be monitored within the computer network;
selecting at least one object to be monitored from under-monitored objects within the computer network, said selecting based upon monitoring resources remaining after reducing resources required for monitoring the mandatory objects, from the available resources; and
sampling data in accordance with the selection.
